(19) United States
(12) Patent Application Publication
(10) Pub. No.: US 2026/0111187 A1
(43) Pub. Date: Apr. 23, 2026

(54) PRAGMA GENERATION AND VERIFICATION USING ARTIFICIAL INTELLIGENCE

(71) Applicant: NVIDIA Corporation, Santa Clara, CA (US)

(72) Inventor: Kalyanasundaram KRISHNAMANI, San Jose, CA (US)

(73) Assignee: NVIDIA Corporation, Santa Clara, CA (US)

(21) Appl. No.: 19/235,348

(22) Filed: Jun. 11, 2025

Related U.S. Application Data
(60) Provisional application No. 63/709,475, filed on Oct. 20, 2024.

(51) Int. Cl. G06F 8/35

(52) U.S. Cl. CPC G06F 8/35

(57) ABSTRACT

In various examples, systems and methods for generating pragma invariants using generative artificial intelligence are disclosed. A system can receive a target code segment and a corresponding specification. The system can generate, using a language model, a set of invariants for the target code segment based at least on the corresponding specification. The system can update the target code segment to include the set of invariants. The system can execute a logical solver to verify the updated target code segment based at least on the set of invariants.

### CROSS-REFERENCES TO RELATED APPLICATIONS

This application claims the benefit of and priority to U.S. Provisional Patent Application No. 63/709,475, filed Oct. 20, 2024, the content of which is incorporated herein by reference in its entirety for all purposes.

### BACKGROUND

Software programs can be designed to perform specific tasks using functions, loops, classes, or other operations. Verifying the correctness of software code is important for making sure the software implements its intended functionality. However, proving the correctness of software programs can be challenging and time-consuming, often requiring specialized knowledge and techniques.

### SUMMARY

This disclosure relates to techniques for pragma generation and verification using generative artificial intelligence. Conventional approaches for program verification often require manual specification of logical conditions, such as loop invariants and other assertions, which can be time-consuming and error-prone. Existing automated techniques for invariant generation face several technical limitations in terms of the complexity of logical conditions they can produce and their applicability to real-world programs. For example, some prior approaches are restricted to programs with only integer variables and cannot handle more complex data structures or language features. Additionally, existing automated techniques rely on predefined templates or heuristics that limit the applicability of the generated logical conditions.

The techniques described herein can be used to automatically generate program invariants/variants/assertions using language models. To do so, the techniques described herein can execute a language model fine-tuned on a dataset of programs with and without invariants/variants/assertions for various types of programming languages, program types, and/or logical condition types. The fine-tuned model can receive as input a program specification including preconditions and postconditions. Based on the specification, the model can generate candidate logical conditions to be inserted at appropriate locations in the program implementation. In some implementations, the techniques can employ a logical prover to verify that the generated logical conditions are sufficient to prove the specified pre-conditions and/or post-conditions. The techniques described herein can be used to generate logical conditions for a variety of programs and programming languages without relying on predefined templates or heuristics.

At least one aspect relates to one or more processors. The one or more processors can include one or more circuits. The one or more circuits can receive a target code segment (e.g., input code) and a corresponding specification (e.g., an. ads file, pre-conditions, post-conditions, in natural language for instance). The one or more circuits can generate, using a language model (e.g., fine-tuned model), a set of logical conditions (e.g., pragma code) for the target code segment based at least on the corresponding specification. The one or more circuits can update the target code segment to include the set of logical conditions. The one or more circuits can execute a logical solver to verify/validate the updated target code segment based at least on the set of logical conditions.

In some implementations, the one or more circuits can update (e.g., fine-tune, train) the language model using a dataset comprising a training code segment and a corresponding updated code segment. In some implementations, the corresponding specification comprises at least one pre-condition and at least one post-condition for the target segment. In some implementations, the target code segment comprises at least one of a function or a loop. In some implementations, the one or more circuits can generate the set of logical conditions to include at least one nested quantifier based at least on the target code segment and the corresponding specification.

In some implementations, the one or more circuits can identify an error (e.g., invalid invariant) in an output of the logical solver. In some implementations, the one or more circuits can generate an output message indicating the error. In some implementations, the one or more circuits can provide the error as input to a second language model to generate a corrected set of logical conditions. In some implementations, the one or more circuits can update the target code segment based at least on the corrected set of logical conditions. In some implementations, the one or more circuits can retrieve at least a portion of an electronic document using a search operation and the error. In some implementations, the one or more circuits can provide the portion of the electronic document as input to the second language model with the error to generate the corrected set of logical conditions. In some implementations, the one or more circuits can receive the corresponding specification in a natural language format.

At least one aspect relates to a system. The system can include one or more processors. The system can generate, using a language model, a first set of logical conditions for a target code segment. The system can determine, using a logical solver, that the first set of logical conditions fails to satisfy a code specification for the target code segment. Upon determining that the first set of logical conditions fails to satisfy the code specification, the system can execute a search operation using at least a portion of the target code segment to obtain at least a portion of an electronic document. The system can generate, using the language model, a second set of logical conditions for the target code segment using the target code segment and the portion of the electronic document. The second set of logical conditions can address deficiencies of the first set of logical conditions. The system can integrate the second set of logical conditions into structure of the target code.

In some implementations, the system can determine, using the logical solver, that the second set of invariants satisfies the code specification. In some implementations, the system can provide an output indicating that the second set of logical conditions satisfies the code specification.

In some implementations, the system can generate an error using the logical solver and the first set of logical conditions. In some implementations, the system can execute the search operation further based on the error. In some implementations, the system can generate, using the language model, the second set of logical conditions using the target code segment, the error, and the portion of the electronic document. In some implementations, the code specification is provided in a natural language format.

At least one other aspect relates to a method. The method can be performed, for example, by one or more processors coupled to non-transitory memory. The method can include receiving a target code segment and a corresponding specification. The method can include generating, using a language model, a set of logical conditions for the target code segment based at least on the corresponding specification. The method can include updating the target code segment to include the set of logical conditions. The method can include executing a logical solver to verify the updated target code segment based at least on the set of logical conditions.

In some implementations, the method can include updating the language model using a dataset comprising a training code segment and a corresponding updated code segment. In some implementations, the corresponding specification comprises at least one pre-condition and at least one post-condition for the target segment. In some implementations, the target code segment comprises at least one of a function or a loop.

The processors, systems, and/or methods described herein can be implemented by or included in at least one of a control system for an autonomous or semi-autonomous machine, a perception system for an autonomous or semi-autonomous machine, a system for performing simulation operations, a system for performing digital twin operations, a system for performing light transport simulation, a system for performing collaborative content creation for 3D assets, a system for performing deep learning operations, a system for performing generative AI operations using a small language model, a system for performing generative AI operations using a large language model, a system for performing generative AI operations using a vision language model, a system implemented using an edge device, a system implemented using a robot, a system for performing conversational AI operations, a system for generating synthetic data, a system incorporating one or more virtual machines (VMs), a system implemented at least partially in a data center, or a system implemented at least partially using cloud computing resources.

### BRIEF DESCRIPTION OF THE DRAWINGS

The present systems and methods for implementing pragma generation and verification using artificial intelligence are described in detail below with reference to the attached drawing figures, wherein:

FIG. 1 is a block diagram of an example system for automatic generation of invariants/variants/assertions using generative artificial intelligence, in accordance with some embodiments of the present disclosure;

FIG. 2 depicts an example data flow diagram showing a process for generating invariants/variants/assertions using generative artificial intelligence using iterative feedback, in accordance with some embodiments of the present disclosure;

FIG. 3 is a flow diagram of an example method for automatic generation of invariants/variants/assertions using generative artificial intelligence, in accordance with some embodiments of the present disclosure;

FIG. 4A is a block diagram of an example generative language model system suitable for use in implementing at least some embodiments of the present disclosure;

FIG. 4B is a block diagram of an example generative language model that includes a transformer encoder-decoder suitable for use in implementing at least some embodiments of the present disclosure;

FIG. 4C is a block diagram of an example generative language model that includes a decoder-only transformer architecture suitable for use in implementing at least some embodiments of the present disclosure;

FIG. 5 is a block diagram of an example computing device suitable for use in implementing at least some embodiments of the present disclosure; and

FIG. 6 is a block diagram of an example data center suitable for use in implementing at least some embodiments of the present disclosure.

### DETAILED DESCRIPTION

Systems and methods are disclosed related to deductive program verification approaches applicable to a variety of software systems. Deductive program verification techniques can use formal logical specifications, such as preconditions, postconditions, loop invariants, or termination variants, among others, to mathematically establish that software code accomplishes its intended purpose. Verifying software code in this manner typically involves explicitly defining conditions for states of variables before or after specific code segments. Such conditions enable logical verification provers to determine whether the corresponding software code functions as intended.

Conventional verification approaches require all logical constraints for the software to be specified via manual input, which may require formulation of a variety of intermediate logical assertions. Identifying suitable loop invariants or intermediate assertions can present significant challenges, resulting in multiple iterations of trial-and-error to achieve useful output. To address these challenges, the techniques described herein use language models to automatically generate logical assertions for deductive program verification. Rather than relying on manual specification or iterative trial-and-error to specify appropriate logical conditions to verify segments of source code, the techniques described herein can automatically invoke language models trained/updated to generate suitable logical conditions for incorporation into provided code. Any type of logical condition or software requirement may be generated using the techniques described herein, including invariants, loop invariants, assertion pragmas, variants, termination variants, or other logical conditions that can be used by logical provers to verify the correctness of software code.

Logical prover systems can process the logical conditions generated by the language models to evaluate the corresponding software code. In some implementations, the techniques described herein can implement a feedback loop to address possible errors in initial output. For example, if the logical provers identify errors and/or inconsistencies in the logical conditions generated by the language model are identified, those errors can be provided as input to one or more language models to generate updated logical conditions to address the errors. In some implementations, retrieval-augmented generation (RAG) techniques can be used to automatically provide additional context data corresponding to relevant logical conditions to reduce errors.

To implement the techniques described herein, a target source code segment, together with any initial developer-specified preconditions or postconditions, can be provided as input to a fine-tuned language model. In some implementations, the initial logical constraints, pre-conditions, or post-conditions can be provided in a natural language format for the language model to convert into formal verification language syntax. The language model can be executed to process the source code, pre-conditions, and/or post-conditions to generate corresponding logical assertions, including loop invariants, variants, or derived assertions. The output of the language model may be formatted according to syntax rules of a corresponding logical prover system.

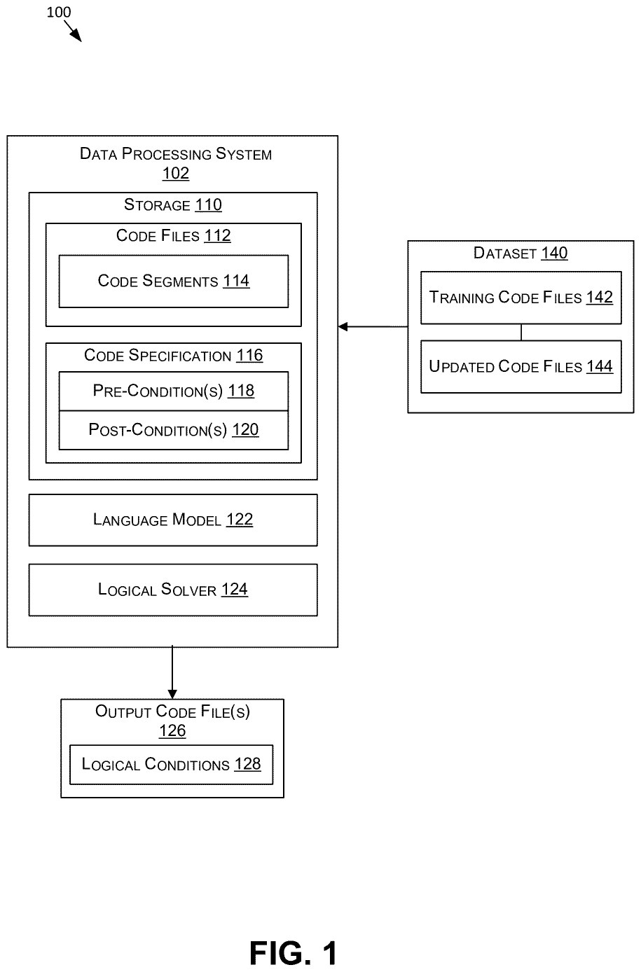

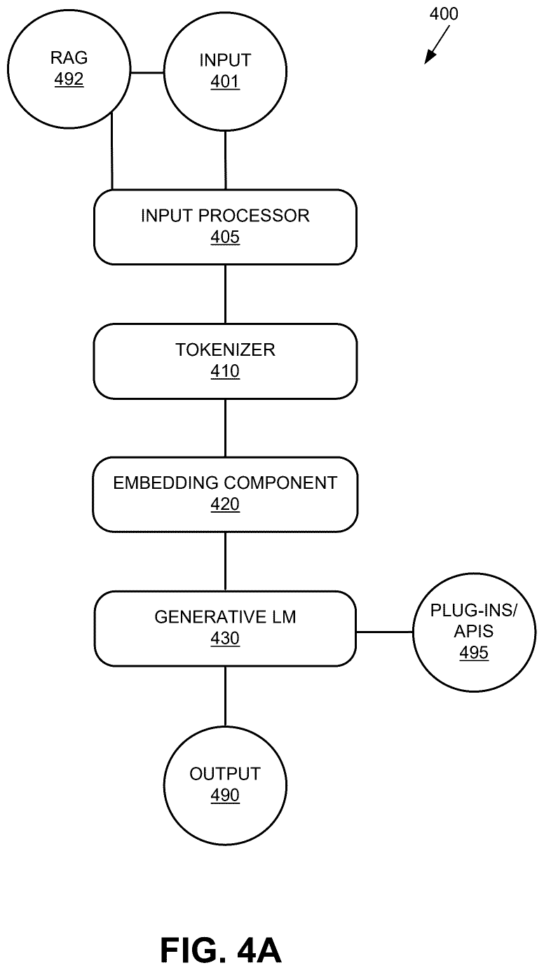

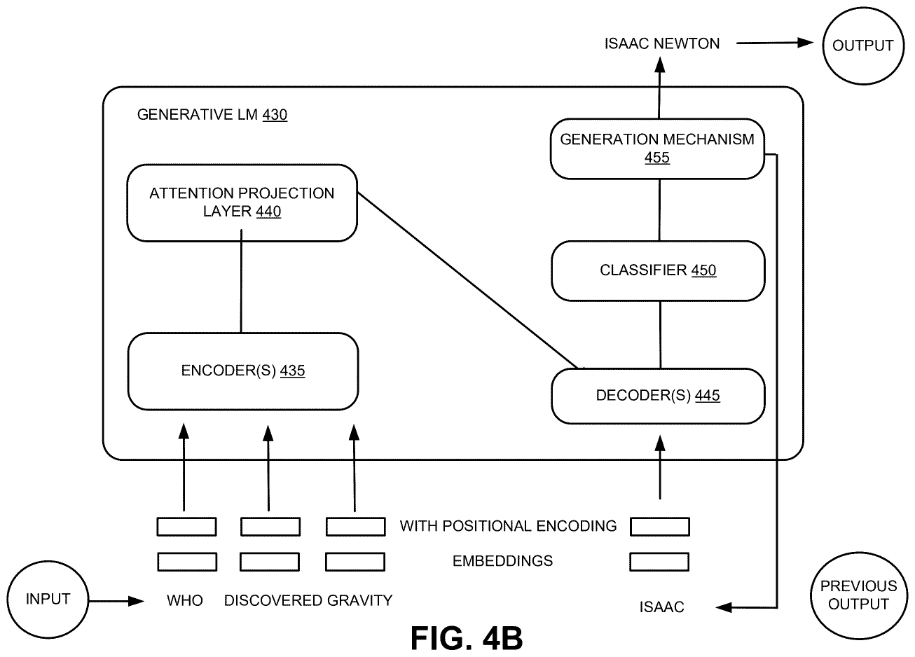

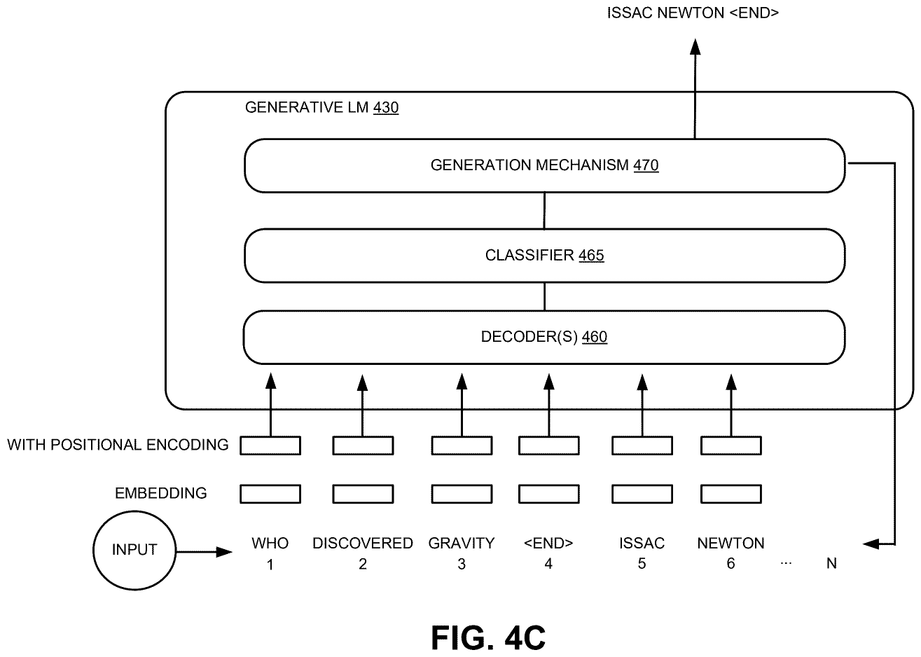

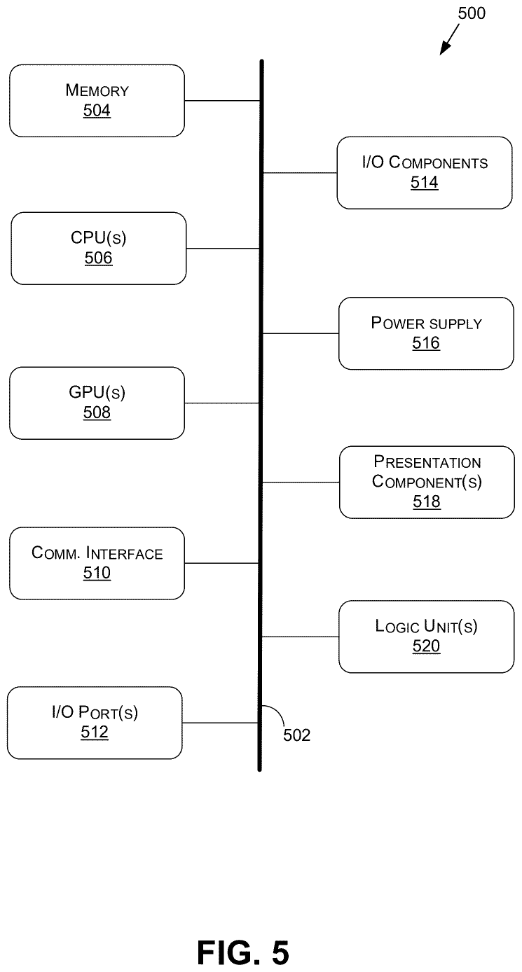

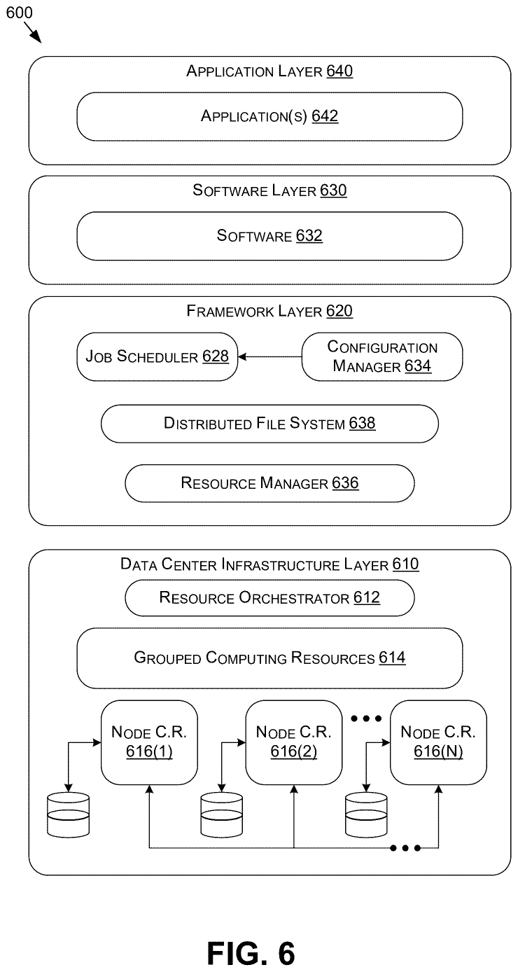

With reference to FIG. 1, FIG. 1 is an example computing environment including a system 100 for automatic generation of invariants/variants/assertions using generative artificial intelligence, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by one or more processor(s) executing instructions stored in memory. For example, in some embodiments, the system and methods described herein may be implemented using one or more generative language models (e.g., as described in FIGS. 4A-4C), one or more computing devices or components thereof (e.g., as described in FIG. 5), and/or one or more data centers or components thereof (e.g., as described in FIG. 6).

FIG. 1 illustrates a block diagram of an example system 100 for automatic generation of invariants/variants/assertions using generative artificial intelligence, in accordance with one or more implementations. The system 100 can include at least one data processing system 102, at least one storage 110, at least one language model 122, at least one logical solver 124, and at least one dataset 140. The storage 110 can include one or more code files 112, one or more code segments 114, and at least one code specification 116. The code specification 116 can include one or more pre-conditions 118 and one or more post-conditions 120. The dataset 140 can include one or more training code segments 142 and one or more updated code segments 144. The data processing system 102 can generate one or more output code files 126 that include one or more logical conditions 128 (e.g., invariants, variants, assertions, etc.).

The data processing system 102 can be implemented using hardware, software, or combinations thereof. The data processing system 102 can include one or more processors, memory devices, storage devices, input devices, output devices, network interfaces, or peripheral components, among others. The data processing system 102 can execute instructions stored in the memory devices to perform operations related to invariant/variant/assertion generation and program verification. In some implementations, the data processing system 102 can be implemented as a server system, a cloud-based computing platform, a distributed computing system, a desktop computer, a laptop computer, or a mobile device, among others.

The data processing system 102 can operate as a standalone computing system or as part of a distributed computing environment. In some implementations, the data processing system 102 can be deployed in a cloud computing environment with multiple virtual machines or containers running in parallel to process large volumes of code for invariant/variant/assertion generation. In distributed computing implementations, the data processing system 102 may provide application programming interfaces that enable external computing devices to submit code segments 114 and/or code specifications 116 for processing according to the techniques described herein. For example, external computing devices, such as desktop computers, laptop computers, or mobile devices, among others, can connect to the data processing system 102 through wired or wireless network connections to perform the invariant/variant/assertion generation techniques described herein. In some implementations, the data processing system 102 can communicate with external version control systems to automatically process code changes and generate updated logical conditions 128 (e.g., invariants, variants, assertions, etc.) when developers commit new code to various code repositories.

In some implementations, the data processing system 102 can include hardware accelerators for machine learning operations, such as tensor processing units, graphics processing units (GPUs), field-programmable gate arrays (FPGAs), and/or application-specific integrated circuits (ASICs), among others. The hardware accelerators can be used to improve computational performance for various techniques such as matrix multiplication operations, convolution operations, or attention mechanism computations implemented by the language model 122. In some implementations, the data processing system 102 can communicate with external systems through the network interfaces to access additional computing resources, reference data, or external services. In some implementations, the language model 122 may be executed via one or more external computing systems. In such implementations, the data processing system 102 can access the language model 122 via one or more application programming interfaces (APIs) to perform various operations described herein.

The data processing system 102 is shown as including the storage 110. The storage 110 can be a computer-readable memory that can store or maintain any of the information described herein. The storage 110 can store/maintain one or more data structures, which may contain, index, or otherwise store each of the values, pluralities, sets, variables, vectors, numbers, or thresholds described herein. The storage 110 can be accessed using one or more memory addresses, index values, or identifiers of any item, structure, or region maintained in the storage 110. The storage 110 can be accessed by the components of the data processing system 102, or any other computing device described herein. As shown, in this example, the storage 110 is internal to the data processing system 102. In some implementations, the storage 110 may be external to and in communication with the data processing system 102. For example, the storage 110 may be an external server, distributed storage/computing environment (e.g., a cloud storage system), or any other type of storage device or system that is in communication with the data processing system 102.

The storage 110 is shown as storing one or more code files 112. The code files 112 can include source code written in various programming languages, such as SPARK, Ada, C, Java, or Python, among others. The code files 112 can be stored according to any suitable storage arrangement or format. In one example, the code files 112 can be organized in a hierarchical directory structure within the storage 110. In some implementations, the code files 112 can be received from external computing devices through network interfaces of the data processing system 102. The code files 112 can be indexed using identifiers, file paths, or metadata tags. In some implementations, the code files 112 can be stored in a version control system that maintains different versions of the code files 112 over time. The version control may be implemented as part of one or more source code repositories. The code files 112 can be compressed, encrypted, or formatted according to specific file formats based on the programming language or development environment from which the code files 112 are provided.

The code files 112 can include one or more code segments 114. The code segments 114 can be portions of the code files 112, including but not limited to functions, loops, classes, or methods, among others. In some implementations, a code segment 114 may be the entirety of a code file 112. In some implementations, one or more code segments 114 can be extracted from the code files 112 using suitable parsing techniques. In some implementations, the code segments 114 can be annotated with metadata indicating the start and end positions within the code files 112. In some implementations, the code segments 114 can be associated with specific verification tasks or analysis operations to be performed by the data processing system 102. The code segments 114 and/or code files 112 may include one or more indications of associated code specifications 116, preconditions 118, and/or post conditions 119 to facilitate the invariant/variant/assertion generation techniques described herein. The code segments 114 may be or include code specifications 116. In one example, a code segment 114 and/or a specification 116 can include an .ads file.

The storage 110 is shown as storing one or more code specifications 116. The code specifications 116 can include formal descriptions of program behavior, including pre-conditions 118 and post-conditions 120 for the code segments 114. The code specifications 116 can be stored in various formats, such as structured files or annotation comments within the code files 112. In some implementations, the code specifications 116 can be written in formal specification languages, such as SPARK annotation language, Hoare logic notation, or other formal verification syntax. The code specifications 116 can be indexed using metadata tags, identifiers, or file path references that associate each specification 116 with its corresponding code segment 114 and/or code file 112. The code specifications 116 can include mathematical expressions, logical assertions, or natural language descriptions that define the expected behavior of the code segments 114.

The code specifications 116 can be received from external computing devices through network interfaces of the data processing system 102. The code specifications 116 can be manually authored by operators of the data processing system 102 and/or external computing systems. In some implementations, the code specifications 116 can be derived from test cases, user requirements documents, or design specifications. In some implementations, the data processing system 102 can parse the code specifications 116 to extract relevant information for invariant/variant/assertion generation. In some implementations, the code specifications 116 can be versioned with the code files 112 using version control systems. The code specifications 116 can be provided for each code segment 116 for which logical conditions 128 (e.g., invariants, variants, assertions, etc.) are to be generated, which as described herein may include functions, methods, loops, modules, or classes. The storage 110 can store/maintain associations between the code specifications 116 and their corresponding code segments 114 using reference tables, pointers, or database entries, among other associations.

The code specification 116 can include pre-conditions 118 and/or post-conditions 120 for one or more code segments 114. The pre-conditions 118 can define constraints or assumptions that must be true before execution of the code segments 114, such as valid input ranges, non-null values, or memory allocation requirements, among others. The post-conditions 120 can specify expected outcomes or states that must be true after execution of the code segments 114, such as output value ranges, data structure properties, or memory deallocation guarantees, among others. In some implementations, the pre-conditions 118 and post-conditions 120 can be expressed using formal specification languages, mathematical notation, or annotated comments within the code files 112. The pre-conditions 118 and post-conditions 120 can be used by the logical solver 124 to verify the correctness of the code segments 114 with respect to the specified behavior, as described in further detail herein.

The data processing system 102 is shown as including at least one language model 122. The language model 122 can be a neural network-based model trained/updated on large corpora of text data to understand and generate human-like text. The language model 122 can include various architectures such as transformer-based models, recurrent neural networks, or encoder-decoder structures, among others. In some implementations, the language model 122 may be updated/fine-tuned/trained using reinforcement learning techniques. In some implementations, the language model 122 can include one or more attention layers, feed-forward networks, and/or normalization layers to process input text and generate output text. The language model 122 may be or include a pre-trained model that is trained/updated using general text corpora. In some implementations, the data processing system 102 can fine-tune or otherwise update the language model 122 (or adapter layer(s) for the language model 122) using the dataset 140, as described in further detail herein.

The language model 122 can be stored within memory devices of the data processing system 102 or may be accessed from external storage systems via one or more network interfaces. The language model 122 can be executed by the data processing system 102 using one or more processors, memory devices, and/or hardware accelerator circuits. In some implementations, the language model 122 can be obtained from external model repositories. In some implementations, the language model 122 can be accessed through APIs provided via external computing systems. For example, the language model 122 can be hosted on remote servers or cloud platforms that offer machine-learning operations as a service. In some implementations, the data processing system 102 can communicate with the external computing systems using authentication tokens, encryption protocols, or secure socket layers, among others. The APIs can provide/expose various functionalities of the language model 122, such as general text generation, loading of fine-tuned adapter layers, or metadata querying, among other operations.

In some implementations, the data processing system 102 can update the language model 122 using the dataset 140. The dataset 140 can include training code segments 142 and corresponding ground-truth updated code segments 144 that include invariants/variants/assertions. The dataset 140 can be stored in various formats, such as structured files, databases, or distributed repositories, among others. The training code segments 142 and corresponding ground-truth updated code segments 144 of the dataset 140 can be obtained from various sources, such as code repositories, software libraries, via input to the data processing system 102, and/or from external computing systems, among other sources. In some implementations, the training code segments 142 of the dataset 140 can be generated by accessing existing ground-truth code segments 144 that include invariants/variants/assertions, and automatically removing the invariants/variants/assertions. In some implementations, the dataset 140 can include metadata tags or other data structures that associate each training code segment 142 with its corresponding updated code segment 144.

The training code segments 142 can include corresponding code specifications that specify the pre-conditions and/or post-conditions for the invariants/variants/assertions in the corresponding ground-truth updated code segments 144. In some implementations, the code specifications can be stored as metadata associated with the training code segments 142. The code specifications can include any number of pre-conditions, post-conditions, or other formal descriptions of expected program behavior. The code specifications can be written in formal specification languages, such as SPARK annotation language, Hoare logic notation, or other specification languages.

The dataset 140 can be structured according to various criteria, such as programming language, code segment type (e.g., loop, function, etc.), or application domain, among others. The dataset 140 can include training code segments 142 and corresponding ground truth updated code segments 144 in various programming languages, such as SPARK, Ada, C, Java, Rust, or Python, among others. In some implementations, the dataset 140 can be partitioned into training, validation, and testing subsets to evaluate the performance of the language model 122 during and after the training/update processes described herein. In some implementations, the dataset 140 can include training code segments 142 and corresponding ground truth updated code segments 144 with varying levels of complexity. In some implementations, the data processing system 102 can pre-process the dataset 140, for example, by normalizing code formatting, removing comments, or tokenizing the code according to the architecture of the language model 122.

In some implementations, the dataset 140 may be an external storage repository or storage system. For example, the dataset 140 can be a computer-readable memory that can store or maintain any of the information described herein. As shown, in this example, the dataset 140 is external to and in communication with the data processing system 102. For example, the storage 110 may be an external server, distributed storage/computing environment (e.g., a cloud storage system), or any other type of storage device or system that is in communication with the data processing system 102. In some implementations, the dataset 140 may be internal to the data processing system 102. For example, the dataset 140 may be stored within the storage 110 of the data processing system 102 or within one or more other memory devices of the data processing system 102.

The data processing system 102 can access the dataset 140 to train/update/fine-tune one or more of the language models 122. The training/updating/fine-tuning process can include adjusting the parameters of the language model 122 to improve the generation of effective logical conditions 128 (e.g., invariants, variants, assertions, etc.) for program verification. In some implementations, the data processing system 102 can update specific layers of the language model 122, such as attention layers or feed-forward networks, rather than updating all layers or parameters of the language model 122. For example, the data processing system 102 can freeze (e.g., hold constant) certain layers of the language model 122 while updating the parameters other layers, which may reduce overfitting on the dataset 140. The data processing system 102 can use techniques such as gradient descent, learning rate scheduling, and/or early stopping to control the training/updating/fine-tuning process of the language model 122.

In some implementations, the data processing system 102 can generate and/or update one or more adapter layers for the language model 122 instead of modifying the base model parameters. The adapter layers may include Low-Rank Adaptation (LoRA) layers, prefix tuning components, or prompt tuning vectors, among others. In such implementations, the data processing system 102 can insert the adapter layers at various positions within the language model 122 to modify the behavior of the model for invariant/variant/assertion generation tasks. In some implementations, the data processing system 102 can train/update multiple adapter layers with different configurations and select the adapter having the greatest validation metrics for a specific dataset 140 (e.g., tailored to a specific programming language, type of code segment, etc.). The data processing system 102 can store the updated/trained adapter layers separately from the base language model 122, and can access the trained/updated adapter layers to execute different fine-tuned versions of the language model 122 for different invariant/variant/assertion generation tasks.

The data processing system 102 can use the training code segments 142 and the ground-truth updated code segments 144 to train/update/fine-tune the language model 122 through an iterative training process. The data processing system 102 can input each training code segment 142 into the language model 122 and compare the generated output to the corresponding ground-truth updated code segment 144. Based on the comparison, the data processing system 102 can determine a loss value that quantifies the difference between the generated output and the ground-truth. The data processing system 102 can then adjust the parameters of the language model 122 using techniques such as backpropagation and gradient descent to minimize the loss value.

In some implementations, during the fine-tuning/training/update process, the data processing system 102 can partition the dataset 140 into training and validation sets of the training code segments 142 to both train/update/fine-tune and validate the language model 122. The training set may include a larger portion of the training code segments 142, such as 80% or 90% of the total dataset 140, while the validation set can include the remaining portion or a subset thereof. In some implementations, the data processing system 102 can use any suitable sampling techniques to generate the training and validation sets across different programming languages, code segment types, and/or complexity levels represented in the dataset 140. The data processing system 102 can use the training set to update the parameters of the language model 122 and/or adapter layers, and can use the validation set to evaluate the performance of the fine-tuned model on unseen data.

The data processing system 102 can implement various termination criteria for the training/update/fine-tuning process of the language model 122. In some implementations, the data processing system 102 can set a maximum number of epochs or iterations as a termination criterion. In another example, the data processing system 102 can monitor the validation loss or other performance metrics during fine-tuning/updating/training and can implement early stopping if the validation performance does not improve for a specified number of consecutive epochs. In some implementations, the data processing system 102 can use a combination of criteria, such as reaching a target validation accuracy threshold or observing a plateau in the learning curve.

The data processing system 102 can receive a target code segment 114 and a corresponding specification 116. The data processing system 102 can receive the target code segment 114 from various sources, such as external computing devices, code repositories, or user input interfaces, among others. The target code segment 114 can be extracted from the code files 112 stored in the storage 110 using parsing techniques that identify function boundaries, loop structures, or method definitions, among others. In some implementations, the data processing system 102 can receive the target code segment 114 as part of a verification request submitted via an API provided by the data processing system 102 or a computing system in communication with the data processing system 102. In some implementations, the data processing system 102 can automatically identify the target code segment 114 by parsing/searching through one or more of the code files 112 to identify portions (e.g., segments) that lack invariants/variants/assertions. The corresponding specification 116 can be provided separately from the target code segment 114 or can be embedded within the target code segment 114 as annotation comments, pragma directives, or formatted documentation strings, among other formats.

In some implementations, the data processing system 102 can receive the corresponding specification 116 in a natural language format. The natural language format can include descriptive statements about the expected behavior of the target code segment 114, such as input constraints, output guarantees, or state invariants/variants/assertions, among others. The code specification 116 in the natural language format can be provided through various interfaces, such as documentation comments within the code files 112, separate requirement/specification documents, or interactive interfaces (e.g., a chatbot interface, etc.). The data processing system 102 can use the language model 122 to interpret ambiguous natural language descriptions and generate logical conditions 128 (e.g., invariants, variants, assertions, etc.) according to the techniques describe herein.

The data processing system 102 can use the language model 122 to generate a set of logical conditions 128 (e.g., invariants, variants, assertions, etc.) for the target code segment 114 based at least on the corresponding specification 116. In some implementations, the logical conditions 128 can include ghost code, which can include auxiliary logic that is not part of the program indicated in the target code segment 114, but is added to prove a target logical aspect/property of the target code segment 114. The data processing system 102 can provide the target code segment 114 and the corresponding specification 116 as input to the language model 122 through a structured prompt format. For example, the data processing system 102 can format the input as a text string including the target code segment 114 followed by the corresponding specification 116. In some implementations, suitable delimiter tokens separating the different input components may be inserted in the text string. In some implementations, the data processing system 102 can tokenize the target code segment 114 and the corresponding specification 116 prior to providing the tokenized input to the language model 122.

The language model 122 can process the input using attention mechanisms, feed-forward networks, and/or normalization layers (among other possible machine-learning layers) to generate the set of logical conditions 128. The data processing system 102 can receive the generated logical conditions 128 from the language model 122 in various formats, such as complete code files 126 with inserted logical conditions 128, diff-style output indicating the changes to be made to add the invariants, and/or structured output indicating the expressions of the logical conditions 128 and their insertion corresponding locations, among other possible formats. When generating output logical conditions 128 in a diff format, the data processing system 102 can receive logical conditions 128 in a format includes the lines to be inserted and/or modified in the target code segment 114, with each diff entry indicating a line number, an operation type (add, modify, or delete), and the invariant expression(s). In some implementations, the data processing system 102 can generate the logical conditions 128 as part of the output code files 126, where each output code file 126 includes the original target code segment 114 with the logical conditions 128 inserted at appropriate locations, such as before loop statements, within function bodies, or at function entry points.

In some implementations, the data processing system 102 can generate the set of logical conditions 128 to include at least one nested quantifier based at least on the target code segment 114 and the corresponding specification 116. Fine-tuning of the language model 122 according to the techniques described herein can enable the language model 122 to identify and generate suitable logical conditions 128 involving quantifiers and/or nested quantifiers. Examples of nested quantifiers in the logical conditions 128 can may include properties such as “for all elements in an array, there exists another element with a specific relationship,” or “for all indices i and j where i<j, a certain property holds between array[i] and array[j].”

In some implementations, the data processing system 102 can update the target code segment 114 to include the set of logical conditions 128. For example, the data processing system 102 can insert the logical conditions 128 as modifications to the target code segment 114 using a diff-based approach that identifies corresponding insertion locations. The data processing system 102 can the output of the language model 122 to extract the specific locations and content for each logical condition 128 to be inserted. In some implementations, the data processing system 102 can maintain a line offset counter that adjusts for previously applied modifications when processing subsequent modifications. In some implementations, the data processing system 102 can use syntax checking rules to validate each modification before applying the change to confirm syntactic correctness according to the programming language of the target code segment 114. In some implementations, the data processing system 102 can generate a modification report that indicates all modifications made to the target code segment 114, including the location and content of each inserted logical condition 128. The data processing system 102 can store the updated target code segment(s) 114 with the applied logical conditions 128 as part of the output code files 126, or may provide the updated target code segment(s) 114 as the output code file(s) 126 including the generated logical conditions 128.

The data processing system 102 can execute a logical solver 124 to verify the updated target code segment 114 based at least on the set of logical conditions 128. The logical solver 124 can apply one or more verification functions to determine whether the logical conditions 128 are sufficient to prove the pre-conditions 118 and/or post-conditions 120 specified in the code specification 116. To do so, the data processing system 102 can provide the updated target code segment 114 with the inserted logical conditions 128 as input to the logical solver 124. Although shown as internal to the data processing system 102, in some implementations, the logical solver 124 may be executed via one or more external computing systems and communicated with via one or more APIs or other communication interfaces. In some implementations, the data processing system 102 can configure the logical solver 124 using specific verification parameters, such as timeout limits, memory constraints, or proof strategies, among others. The logical solver 124 can generate verification conditions from the updated target code segment 114 and attempt to prove each verification condition using mathematical logic and automated reasoning techniques. The data processing system 102 can monitor the execution of the logical solver 124 and can collect the verification results for further processing or display. The logical solver 124 can implement any type of logical verification function, including but not limited to satisfiable modulo theory (SMT) solvers or verification functions that can generate verification conditions for the updated target code segment 114 to verify the generated logical conditions 128.

In some implementations, the data processing system 102 can identify one or more errors in an output of the logical solver 124. The data processing system 102 can parse the output of the logical solver 124 to detect specific error codes, failure messages, and/or unproven verification conditions. For example, the data processing system 102 can extract error identifiers from the logical solver 124 output and match the error identifiers against a dataset of known error patterns. In some implementations, the data processing system 102 can categorize the identified errors based on error types, such as invariant weakness, invariant insufficiency, logical contradictions, or timeout events, among others. The data processing system 102 can store/maintain one or more data structures including the identified errors along with contextual information about the target code segment 114 and the generated logical conditions 128. In some implementations, the data processing system 102 can associate each identified error with a specific location in the updated target code segment 114, such as a line number, a function name, or a loop structure.

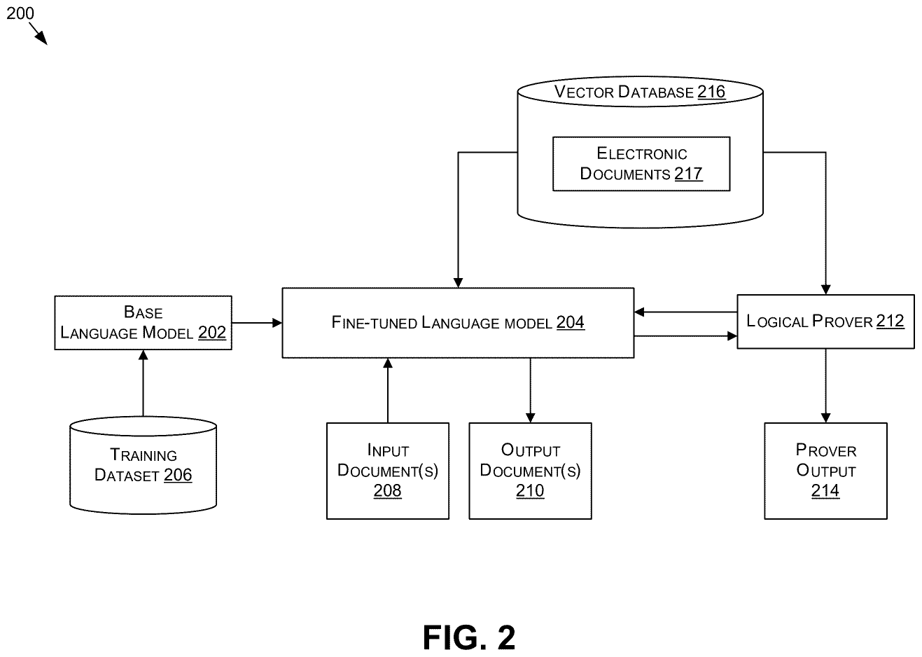

In some implementations, the data processing system 102 can generate an output message indicating the error. The data processing system 102 can format the output message according to various presentation styles, such as console output, structured log entries, or graphical notifications, among others. The output message can include details about the error type, the location in the updated target code segment 114 where the error occurred, and/or potential causes of the error. In some implementations, the data processing system 102 can include suggestions for resolving the error, which may be generated according to the techniques described in connection with FIG. 2. The data processing system 102 can transmit the output message to external computing devices through network interfaces or display the output message through one or more user interfaces of the data processing system 102. In some implementations, the data processing system 102 can store the output message in the storage 110 in association with the target code segment 114.

Upon receiving a signal from the logical solver 124 that the updated target code segment 114 has been logically verified according to the code specification 116, the data processing system 102 can generate one or more output code files 126 that include the generated logical conditions 128. The data processing system 102 can create the output code files 126 using various approaches, such as direct modification of the target code segment 114 or application of diff-style patches, among others. The data processing system 102 can store the output code files 126 in the storage 110 or transmit the output code files 126 to external computing systems through network interfaces. In some implementations, the data processing system 102 can include metadata within the output code files 126 that indicates the source of each logical condition 128. In some implementations, the output code files 126 and/or the updated target code segments 114 can be generated using an iterative approach, as described in connection with FIG. 2.

Referring now to FIG. 2 in the context of the components described in connection with FIG. 1, illustrated is a data flow diagram 200 for processing and analyzing documents using language models, in accordance with example embodiments. The data flow diagram 200 can include at least one base language model 202, at least one finetuned language model 204, at least one training dataset 206, one or more input documents 208, one or more output documents 210, at least one logical prover 212, at least one prover output 214, and at least one vector database 216 storing one or more electronic documents 217.

The data flow diagram 200 can include multiple components/operations that can be used as process input code documents 208 and can generate output code documents 210 with verified invariants/variants/assertions (e.g., logical conditions 128). The operations of the data flow diagram 200 can be performed by a data processing system, which can execute various functions to process code segments (e.g., target code segments 114) and specifications (e.g., code specifications 116).

The base language model 202 can be a baseline foundation model that can be trained/fine-tuned/updated according to the techniques described herein to generate the finetuned language model 204. The base language model 202 can be a neural network-based model trained on large corpora of text data to understand and generate human-like text. In some implementations, the base language model 202 can include various architectures such as transformer-based models, recurrent neural networks, or encoder-decoder structures, among others. The base language model 202 can process input text using attention mechanisms, feed-forward networks, or normalization layers, among other possible machine-learning layers. The base language model 202 can be stored within memory devices of the data processing system or can be accessed from external computing systems via one or more network interfaces.

The training dataset 206 (e.g., the dataset 140) can contain pairs of code segments with and without logical conditions (e.g., training code files 142, ground-truth updated code files 144) for fine-tuning/training/updating the finetuned language model 204. The training dataset 206 can include code segments in various programming languages, such as SPARK, Ada, C, Java, or Python, as described herein. In some implementations, the training dataset 206 can be structured according to various criteria, such as programming language, code segment type, or application domain, among others. The training dataset 206 can be partitioned into training, validation, and/or testing subsets to evaluate the performance of the finetuned language model 204 during and after the fine-tuning/training/update process, as described herein.

The finetuned language model 204 can be an updated version of the base language model 202 that has been fine-tuned/trained/updated using the training dataset 206, according to the techniques described herein. The finetuned language model 204 can receive input documents 208, such as target code segments, and can generate output documents 210 (e.g., output code files 126) including generated invariants/variants/assertions. The finetuned language model 204 can be updated through an iterative training process that adjusts the parameters of the model to minimize the difference between generated outputs and ground-truth examples from the training dataset 206. As shown, the output of the finetuned language model 204 can be provided to the logical prover 212 to verify the generated invariants/variants/assertions. Feedback from the logical prover 212 can be used to refine the invariants/variants/assertions based on the prover output 214.

The logical prover 212 (e.g., the logical solver 124) can verify the correctness of the generated invariants/variants/assertions in output documents 210. The logical prover 212 can apply one or more verification functions to determine whether the invariants/variants/assertions are sufficient to prove the pre-conditions and/or post-conditions specified in the input documents 208. In some implementations, the logical prover 212 can generate verification conditions from the output documents 210 and can attempt to prove each verification condition using mathematical logic and automated reasoning techniques. The logical prover 212 can generate one or more prover outputs 214 that indicates whether the verification was successful or contains error information for failed verifications. The prover output 214 can be used as feedback to the base language model 202 and/or the finetuned language model 204 to generate corrected or strengthened invariants/variants/assertions when verification fails.

The vector database 216 can store electronic documents 217 that can be retrieved during logical condition generation, for example, using a vector search operation (e.g., where the input document 208 or a portion thereof is used as at least part of a query, etc.). In some implementations, the vector database 216 can be queried using search operations based at least on the input documents 208 and/or error information from the prover output 214. In some implementations, the data processing system can retrieve portions of electronic documents 217 from the vector database 216 that using one or more errors identified in the prover output 214 as at least part of queries over the vector database 216. The retrieved electronic documents 217 and/or portions thereof can be provided as additional context to the finetuned language model 204 or the base language model 202 along with the error information to generate corrected logical conditions. The electronic documents 217 of the vector database 216 can include reference materials, code examples, and/or verification patterns that can inform the logical condition generation process. The vector database 216 can be updated with new electronic documents 217 to improve the quality and relevance of the retrieved information for invariant/variant/assertion correction.

An iterative feedback process can be implemented in which the logical prover 212 can generate prover output 214 based on verification of the output documents 210. The prover output 214 can include error information when verification fails, such as unproven verification conditions, logical contradictions, or timeout events, among others. The prover output 214 can be provided to the base language model 202 and/or the finetuned language model 204 through a feedback path, to generate refined logical conditions (e.g., invariants, variants, assertions, etc.) in a subsequent iteration. The refined logical conditions in the updated output documents 210 can be provided as input to the logical prover 212 to perform iterative verification. In some implementations, operator input may be provided as input to the fine-tuned language model 204 (e.g., with the prover output 214) to facilitate generation of corrected logical conditions. Once the prover output 214 indicates that the logical conditions in the output document(s) 210 are correct, the output document(s) 210 can be provided/stored as output.

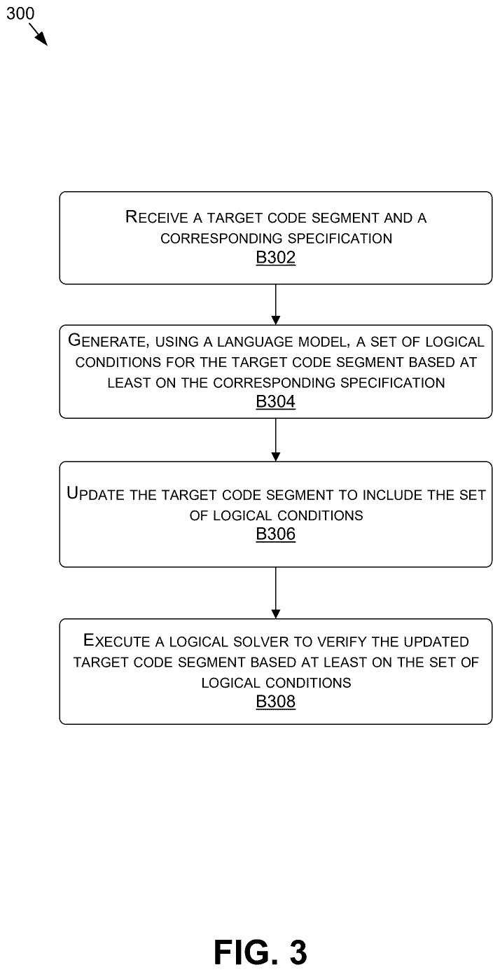

Now referring to FIG. 3, each block of method 300, described herein, includes a computing process that may be performed using any combination of hardware, firmware, and/or software. For instance, various functions may be carried out by one or more processors executing instructions stored in memory. The method 300 may also be embodied as computer-usable instructions stored on computer storage media. The method 300 may be provided by a standalone application, a service or hosted service (standalone or in combination with another hosted service), as a microservice via an application programming interface (API) or a plug-in to another product, to name a few. In addition, method 300 is described, by way of example, with respect to the system 100 of FIG. 1. However, this method may additionally or alternatively be executed by any one system, or any combination of systems, including, but not limited to, those described herein.

FIG. 3 is a flow diagram showing a method 300 for automatically generating invariants/variants/assertions using generative artificial intelligence, in accordance with some embodiments of the present disclosure. The method 300, at block B302, can include receiving a target code segment (e.g., target code segment 114) and a corresponding specification (e.g., code specification 116). The target code segment can be received from various sources, such as external computing devices, code repositories, and/or input to user interfaces, among others. In some implementations, the target code segment can be extracted from code files stored in storage using parsing techniques that identify function boundaries, loop structures, or method definitions, among others. In some implementations, the target code segment can be received as part of a verification request submitted via an API request. The corresponding specification can be provided separately from the target code segment or can be embedded within the target code segment as annotation comments, pragma directives, or formatted strings, among other formats.

The corresponding specification can include formal descriptions of program behavior, including pre-conditions and/or post-conditions for the target code segment. The corresponding specification can be stored in various formats, such as structured files or annotation comments within the code files. In some implementations, the corresponding specification can be written in formal specification languages, such as SPARK annotation language, Hoare logic notation, or other formal verification syntax. The corresponding specification can be indexed using metadata tags, identifiers, or file path references that associate each specification with its corresponding code segment. In some implementations, the corresponding specification can be received in a natural language format that includes descriptive statements about the expected behavior of the target code segment, such as input constraints, output states/variables, or state invariants, among others. The corresponding specification in the natural language format can be provided through various interfaces, such as comments within the code segments/files, separate input documents, or input to user interfaces.

The method 300, at block B304, can include generating, using a language model (e.g., language model 122), a set of logical conditions (e.g., logical conditions 128) for the target code segment based at least on the corresponding specification. As described in connection with FIG. 1, the language model can automatically formulate invariants/variants/assertions that express mathematical or logical properties that hold true at corresponding points during program execution, such as invariants, loop invariants, variants, assertions, function pre-conditions, or post-conditions. The generated set of logical conditions (e.g., logical conditions 128) can include various types of assertions that aid in program verification. The set of invariants/variants/assertions can include expressions involving variables from the target code segment, mathematical operators, logical connectives, or quantifiers. In some implementations, the set of invariants/variants/assertions can include nested quantifiers for expressing complex properties about data structures or relationships between program variables. The language model can generate the invariants/variants/assertions to match the programming language of the target code segment, such as SPARK, Ada, Rust, C, Java, or Python, among others.

In some implementations, additional data such as electronic documents can be retrieved (e.g., using retrieval augmented generation techniques) to supplement the input target code segment and/or code specification. The additional data can be included, for example, as part of the input context for the language model. The language model can process the additional data along with the target code segment and corresponding specification to generate more accurate invariants/variants/assertions. In some implementations, the additional data can include reference materials, code examples, and/or verification patterns (or portions thereof) that relate to the target code segment. In some implementations, the additional data can be stored in a vector database and retrieved using search operations based on features of the target code segment, such as variable types, function signatures, or loop structures, among others. In some implementations, the additional data can be retrieved based on error information from previous verification attempts. The retrieved additional data can provide domain-specific knowledge or verification patterns that can guide the language model in generating suitable invariants/variants/assertions, as described herein. In some implementations, the additional data can be filtered or ranked according to relevance scores computed based on similarity metrics between the additional data and the target code segment.

The method 300, at block B306, can include updating the target code segment to include the set of invariants/variants/assertions. To do so, any of the operations described in connection with FIGS. 1 and 2 may be performed. In some implementations, the output of the language model may include a reproduction of the target code segment with the corresponding invariants/variants/assertions generated according to the code specification at corresponding locations. In some implementations, the target code segment can be updated using a diff-based approach that identifies insertion points for each invariant/variant/assertion. For example, the language model may generate a structured output (e.g., a data structure) that stores each modification to be applied to the target code segment, such as line numbers, operation types, and invariant expressions. In some implementations, the method 300 can use a line offset counter that adjusts for previously applied modifications when processing subsequent changes to the target code segment. In some implementations, each modification can be applied sequentially to generate the updated target code segment with the invariants/variants/assertions inserted at appropriate locations, such as before loop statements, within function bodies, or at function entry points, among others.

The method 300, at block B308, can include executing a logical solver (e.g., logical solver 124) to verify the updated target code segment based at least on the set of invariants/variants/assertions. The logical solver can apply one or more verification functions to determine whether the invariants/variants/assertions are sufficient to prove the pre-conditions and post-conditions specified in the code specification. For example, the logical solver can generate verification conditions from the updated target code segment to prove each verification condition using mathematical logic and automated reasoning techniques, as described herein. In some implementations, the logical solver can implement various verification parameters, such as timeout limits, memory constraints, or proof strategies, among others. The logical solver can process the updated target code segment with the inserted invariants/variants/assertions and can generate verification results indicating whether each verification condition has been successfully proven. In some implementations, the verification results can be stored for further processing or provided for display at a computing device, as described herein. The verification results can include information about each verification condition, such as proof status, execution time, or resource usage, among others.

The systems and methods described herein may be used for a variety of purposes, by way of example and without limitation, for machine (e.g., robot, vehicle, construction machinery, warehouse vehicles/machines, autonomous, semi-autonomous, and/or other machine types) control, machine locomotion, machine driving, synthetic data generation, model training (e.g., using real, augmented, and/or synthetic data, such as synthetic data generated using a simulation platform or system, synthetic data generation techniques such as but not limited to those described herein, etc.), perception, augmented reality (AR), virtual reality (VR), mixed reality (MR), robotics, security and surveillance (e.g., in a smart cities implementation), autonomous or semi-autonomous machine applications, deep learning, environment simulation, object or actor simulation and/or digital twinning, data center processing, conversational AI, light transport simulation (e.g., ray-tracing, path tracing, etc.), distributed or collaborative content creation for 3D assets (e.g., using universal scene descriptor (USD) data, such as OpenUSD, and/or other data types), cloud computing, generative artificial intelligence (e.g., using one or more diffusion models, transformer models, etc.), and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot or robotic platform, aerial systems, medial systems, boating systems, smart area monitoring systems, systems for performing deep learning operations, systems for performing simulation operations (e.g., in a driving or vehicle simulation, in a robotics simulation, in a smart cities or surveillance simulation, etc.), systems for performing digital twin operations (e.g., in conjunction with a collaborative content creation platform or system, such as, without limitation, NVIDIA's OMNIVERSE and/or another platform, system, or service that uses USD or OpenUSD data types), systems implemented using an edge device, systems incorporating one or more virtual machines (VMs), systems for performing synthetic data generation operations (e.g., using one or more neural rendering fields (NERFs), gaussian splat techniques, diffusion models, transformer models, etc.), systems implemented at least partially in a data center, systems for performing conversational AI operations, systems implementing one or more language models - such as one or more large language models (LLMs), one or more small language models (SLMs), one or more vision language models (VLMs), one or more multi-modal language models, etc., systems for performing light transport simulation, systems for performing collaborative content creation for 3D assets (e.g., using universal scene descriptor (USD) data, such as OpenUSD, computer aided design (CAD) data, 2D and/or 3D graphics or design data, and/or other data types), systems implemented at least partially using cloud computing resources, and/or other types of systems.

### EXAMPLE LANGUAGE MODELS

In at least some embodiments, language models, such as large language models (LLMs), small language models (SLMs), vision language models (VLMs), multi-modal language models (MMLMs), and/or other types of generative artificial intelligence (AI) may be implemented. These models may be capable of understanding, summarizing, translating, and/or otherwise generating text (e.g., natural language text, code, etc.), images, video, computer aided design (CAD) assets, OMNIVERSE and/or METAVERSE file information (e.g., in USD format, such as OpenUSD), and/or the like, based on the context provided in input prompts or queries. These language models may be considered “large,” in embodiments, based on the models being trained on massive datasets and having architectures with large number of learnable network parameters (weights and biases) - such as millions or billions of parameters. The LLMs/SLMs/VLMs/MMLMs/etc. may be implemented for summarizing textual data, analyzing and extracting insights from data (e.g., textual, image, video, etc.), and generating new text/image/video/etc. in user-specified styles, tones, and/or formats. The LLMs/SLMs/VLMs/MMLMs/etc. of the present disclosure may be used exclusively for text processing, in embodiments, whereas in other embodiments, multi-modal LLMs may be implemented to accept, understand, and/or generate text and/or other types of content like images, audio, 2D and/or 3D data (e.g., in USD formats), and/or video. For example, vision language models (VLMs), or more generally multi-modal language models (MMLMs), may be implemented to accept image, video, audio, textual, 3D design (e.g., CAD), and/or other inputs data types and/or to generate or output image, video, audio, textual, 3D design, and/or other output data types.

Various types of LLMs/SLMs/VLMs/MMLMs/etc. architectures may be implemented in various embodiments. For example, different architectures may be implemented that use different techniques for understanding and generating outputs—such as text, audio, video, image, 2D and/or 3D design or asset data, etc. In some embodiments, LLMs/SLMs/VLMs/MMLMs/etc. architectures such as recurrent neural networks (RNNs) or long short-term memory networks (LSTMs) may be used, while in other embodiments transformer architectures—such as those that rely on self-attention and/or cross-attention (e.g., between contextual data and textual data) mechanisms—may be used to understand and recognize relationships between words or tokens and/or contextual data (e.g., other text, video, image, design data, USD, etc.). One or more generative processing pipelines that include LLMs/SLMs/VLMs/MMLMs/etc. may also include one or more diffusion block(s) (e.g., denoisers). The LLMs/SLMs/VLMs/MMLMs/etc. of the present disclosure may include encoder and/or decoder block(s). For example, discriminative or encoder-only models like BERT (Bidirectional Encoder Representations from Transformers) may be implemented for tasks that involve language comprehension such as classification, sentiment analysis, question answering, and named entity recognition. As another example, generative or decoder-only models like GPT (Generative Pretrained Transformer) may be implemented for tasks that involve language and content generation such as text completion, story generation, and dialogue generation. LLMs/SLMs/VLMs/MMLMs/etc. that include both encoder and decoder components like T5 (Text-to-Text Transformer) may be implemented to understand and generate content, such as for translation and summarization. These examples are not intended to be limiting, and any architecture type—including but not limited to those described herein—may be implemented depending on the particular embodiment and the task(s) being performed using the LLMs/SLMs/VLMs/MMLMs/etc.

In various embodiments, the LLMs/SLMs/VLMs/MMLMs/etc. may be trained using unsupervised learning, in which an LLMs/SLMs/VLMs/MMLMs/etc. learns patterns from large amounts of unlabeled text/audio/video/image/design/USD/etc. data. Due to the extensive training, in embodiments, the models may not require task-specific or domain-specific training. LLMs/SLMs/VLMs/MMLMs/etc. that have undergone extensive pre-training on vast amounts of unlabeled data may be referred to as foundation models and may be adept at a variety of tasks like question-answering, summarization, filling in missing information, translation, image/video/design/USD/data generation. Some LLMs/SLMs/VLMs/MMLMs/etc. may be tailored for a specific use case using techniques like prompt tuning, fine-tuning, retrieval augmented generation (RAG), adding adapters (e.g., customized neural networks, and/or neural network layers, that tune or adjust prompts or tokens to bias the language model toward a particular task or domain), and/or using other fine-tuning or tailoring techniques that optimize the models for use on particular tasks and/or within particular domains.

In some embodiments, the LLMs/SLMs/VLMs/MMLMs/etc. of the present disclosure may be implemented using various model alignment techniques. For example, in some embodiments, guardrails may be implemented to identify improper or undesired inputs (e.g., prompts) and/or outputs of the models. In doing so, the system may use the guardrails and/or other model alignment techniques to either prevent a particular undesired input from being processed using the LLMs/SLMs/VLMs/MMLMs/etc., and/or preventing the output or presentation (e.g., display, audio output, etc.) of information generating using the LLMs/SLMs/VLMs/MMLMs/etc. In some embodiments, one or more additional models—or layers thereof—may be implemented to identify issues with inputs and/or outputs of the models. For example, these “safeguard” models may be trained to identify inputs and/or outputs that are “safe” or otherwise okay or desired and/or that are “unsafe” or are otherwise undesired for the particular application/implementation. As a result, the LLMs/SLMs/VLMs/MMLMs/etc. of the present disclosure may be less likely to output language/text/audio/video/design data/USD data/etc. that may be offensive, vulgar, improper, unsafe, out of domain, and/or otherwise undesired for the particular application/implementation.

In some embodiments, the LLMs/SLMs/VLMs/MMLMs/etc. may be configured to or capable of accessing or using one or more plug-ins, application programming interfaces (APIs), databases, data stores, repositories, etc. For example, for certain tasks or operations that the model is not ideally suited for, the model may have instructions (e.g., as a result of training, and/or based on instructions in a given prompt) to access one or more plug-ins (e.g., 3^{rd} party plugins) for help in processing the current input. In such an example, where at least part of a prompt is related to restaurants or weather, the model may access one or more restaurant or weather plug-ins (e.g., via one or more APIs) to retrieve the relevant information. As another example, where at least part of a response requires a mathematical computation, the model may access one or more math plug-ins or APIs for help in solving the problem(s), and may then use the response from the plug-in and/or API in the output from the model. This process may be repeated—e.g., recursively—for any number of iterations and using any number of plug-ins and/or APIs until a response to the input prompt can be generated that addresses each ask/question/request/process/operation/etc. As such, the model(s) may not only rely on its own knowledge from training on a large dataset(s), but also on the expertise or optimized nature of one or more external resources—such as APIs, plug-ins, and/or the like.

In some embodiments, multiple language models (e.g., LLMs/SLMs/VLMs/MMLMs/etc., multiple instances of the same language model, and/or multiple prompts provided to the same language model or instance of the same language model may be implemented, executed, or accessed (e.g., using one or more plug-ins, user interfaces, APIs, databases, data stores, repositories, etc.) to provide output responsive to the same query, or responsive to separate portions of a query. In at least one embodiment, multiple language models e.g., language models with different architectures, language models trained on different (e.g., updated) corpuses of data may be provided with the same input query and prompt (e.g., set of constraints, conditioners, etc.). In one or more embodiments, the language models may be different versions of the same foundation model. In one or more embodiments, at least one language model may be instantiated as multiple agents—e.g., more than one prompt may be provided to constrain, direct, or otherwise influence a style, a content, or a character, etc., of the output provided. In one or more example, non-limiting embodiments, the same language model may be asked to provide output corresponding to a different role, perspective, character, or having a different base of knowledge, etc.—as defined by a supplied prompt.

In any one of such embodiments, the output of two or more (e.g., each) language models, two or more versions of at least one language model, two or more instanced agents of at least one language model, and/or two more prompts provided to at least one language model may be further processed, e.g., aggregated, compared or filtered against, or used to determine (and provide) a consensus response. In one or more embodiments, the output from one language model—or version, instance, or agent—maybe be provided as input to another language model for further processing and/or validation. In one or more embodiments, a language model may be asked to generate or otherwise obtain an output with respect to an input source material, with the output being associated with the input source material. Such an association may include, for example, the generation of a caption or portion of text that is embedded (e.g., as metadata) with an input source text or image. In one or more embodiments, an output of a language model may be used to determine the validity of an input source material for further processing, or inclusion in a dataset. For example, a language model may be used to assess the presence (or absence) of a target word in a portion of text or an object in an image, with the text or image being annotated to note such presence (or lack thereof). Alternatively, the determination from the language model may be used to determine whether the source material should be included in a curated dataset, for example and without limitation.

FIG. 4A is a block diagram of an example generative language model system 400 suitable for use in implementing at least some embodiments of the present disclosure. In the example illustrated in FIG. 4A, the generative language model system 400 includes a retrieval augmented generation (RAG) component 492, an input processor 405, a tokenizer 410, an embedding component 420, plug-ins/APIs 495, and a generative language model (LM) 430 (which may include an LLM, a SLM, a VLM, a multi-modal LM, etc.).

At a high level, the input processor 405 may receive an input 401 comprising text and/or other types of input data (e.g., audio data, video data, image data, sensor data (e.g., LiDAR, RADAR, ultrasonic, etc.), 3D design data, CAD data, universal scene descriptor (USD) data—such as OpenUSD, etc.), depending on the architecture of the generative LM 430 (e.g., LLM/SLM/VLM/MMLM/etc.). In some embodiments, the input 401 includes plain text in the form of one or more sentences, paragraphs, and/or documents. Additionally or alternatively, the input 401 may include numerical sequences, precomputed embeddings (e.g., word or sentence embeddings), and/or structured data (e.g., in tabular formats, JSON, or XML). In some implementations in which the generative LM 430 is capable of processing multi-modal inputs, the input 401 may combine text (or may omit text) with image data, audio data, video data, design data, USD data, and/or other types of input data, such as but not limited to those described herein. Taking raw input text as an example, the input processor 405 may prepare raw input text in various ways. For example, the input processor 405 may perform various types of text filtering to remove noise (e.g., special characters, punctuation, HTML tags, stopwords, portions of an image(s), portions of audio, etc.) from relevant textual content. In an example involving stopwords (common words that tend to carry little semantic meaning), the input processor 405 may remove stopwords to reduce noise and focus the generative LM 430 on more meaningful content. The input processor 405 may apply text normalization, for example, by converting all characters to lowercase, removing accents, and/or or handling special cases like contractions or abbreviations to ensure consistency. These are just a few examples, and other types of input processing may be applied.

In some embodiments, a RAG component 492 (which may include one or more RAG models, and/or may be performed using the generative LM 430 itself) may be used to retrieve additional information to be used as part of the input 401 or prompt. RAG may be used to enhance the input to the LLM/SLM/VLM/MMLM/etc. with external knowledge, so that answers to specific questions or queries or requests are more relevant - such as in a case where specific knowledge is required. The RAG component 492 may fetch this additional information (e.g., grounding information, such as grounding text/image/video/audio/USD/CAD/etc.) from one or more external sources, which can then be fed to the LLM/SLM/VLM/MMLM/etc. along with the prompt to improve accuracy of the responses or outputs of the model.

For example, in some embodiments, the input 401 may be generated using the query or input to the model (e.g., a question, a request, etc.) in addition to data retrieved using the RAG component 492. In some embodiments, the input processor 405 may analyze the input 401 and communicate with the RAG component 492 (or the RAG component 492 may be part of the input processor 405, in embodiments) in order to identify relevant text and/or other data to provide to the generative LM 430 as additional context or sources of information from which to identify the response, answer, or output 490, generally. For example, where the input indicates that the user is interested in a desired tire pressure for a particular make and model of vehicle, the RAG component 492 may retrieve—using a RAG model performing a vector search in an embedding space, for example—the tire pressure information or the text corresponding thereto from a digital (embedded) version of the user manual for that particular vehicle make and model. Similarly, where a user revisits a chatbot related to a particular product offering or service, the RAG component 492 may retrieve a prior stored conversation history—or at least a summary thereof—and include the prior conversation history along with the current ask/request as part of the input 401 to the generative LM 430.

The RAG component 492 may use various RAG techniques. For example, naïve RAG may be used where documents are indexed, chunked, and applied to an embedding model to generate embeddings corresponding to the chunks. A user query may also be applied to the embedding model and/or another embedding model of the RAG component 492 and the embeddings of the chunks along with the embeddings of the query may be compared to identify the most similar/related embeddings to the query, which may be supplied to the generative LM 430 to generate an output.

In some embodiments, more advanced RAG techniques may be used. For example, prior to passing chunks to the embedding model, the chunks may undergo pre-retrieval processes (e.g., routing, rewriting, metadata analysis, expansion, etc.). In addition, prior to generating the final embeddings, post-retrieval processes (e.g., re-ranking, prompt compression, etc.) may be performed on the outputs of the embedding model prior to final embeddings being used as comparison to an input query.

As a further example, modular RAG techniques may be used, such as those that are similar to naïve and/or advanced RAG, but also include features such as hybrid search, recursive retrieval and query engines, StepBack approaches, sub-queries, and hypothetical document embedding.

As another example, Graph RAG may use knowledge graphs as a source of context or factual information. Graph RAG may be implemented using a graph database as a source of contextual information sent to the LLM/SLM/VLM/MMLM/etc. Rather than (or in addition to) providing the model with chunks of data extracted from larger sized documents—which may result in a lack of context, factual correctness, language accuracy, etc.—graph RAG may also provide structured entity information to the LLM/SLM/VLM/MMLM/etc. by combining the structured entity textual description with its many properties and relationships, allowing for deeper insights by the model. When implementing graph RAG, the systems and methods described herein use a graph as a content store and extract relevant chunks of documents and ask the LLM/SLM/VLM/MMLM/etc. to answer using them. The knowledge graph, in such embodiments, may contain relevant textual content and metadata about the knowledge graph as well as be integrated with a vector database. In some embodiments, the graph RAG may use a graph as a subject matter expert, where descriptions of concepts and entities relevant to a query/prompt may be extracted and passed to the model as semantic context. These descriptions may include relationships between the concepts. In other examples, the graph may be used as a database, where part of a query/prompt may be mapped to a graph query, the graph query may be executed, and the LLM/SLM/VLM/MMLM/etc. may summarize the results. In such an example, the graph may store relevant factual information, and a query (natural language query) to graph query tool (NL-to-Graph-query tool) and entity linking may be used. In some embodiments, graph RAG (e.g., using a graph database) may be combined with standard (e.g., vector database) RAG, and/or other RAG types, to benefit from multiple approaches.

In any embodiments, the RAG component 492 may implement a plugin, API, user interface, and/or other functionality to perform RAG. For example, a graph RAG plug-in may be used by the LLM/SLM/VLM/MMLM/etc. to run queries against the knowledge graph to extract relevant information for feeding to the model, and a standard or vector RAG plug-in may be used to run queries against a vector database. For example, the graph database may interact with a plug-in's REST interface such that the graph database is decoupled from the vector database and/or the embeddings models.

The tokenizer 410 may segment the (e.g., processed) text data into smaller units (tokens) for subsequent analysis and processing. The tokens may represent individual words, subwords, characters, portions of audio/video/image/etc., depending on the implementation. Word-based tokenization divides the text into individual words, treating each word as a separate token. Subword tokenization breaks down words into smaller meaningful units (e.g., prefixes, suffixes, stems), enabling the generative LM 430 to understand morphological variations and handle out-of-vocabulary words more effectively. Character-based tokenization represents each character as a separate token, enabling the generative LM 430 to process text at a fine-grained level. The choice of tokenization strategy may depend on factors such as the language being processed, the task at hand, and/or characteristics of the training dataset. As such, the tokenizer 410 may convert the (e.g., processed) text into a structured format according to tokenization schema being implemented in the particular embodiment.

The embedding component 420 may use any known embedding technique to transform discrete tokens into (e.g., dense, continuous vector) representations of semantic meaning. For example, the embedding component 420 may use pre-trained word embeddings (e.g., Word2Vec, GloVe, or FastText), one-hot encoding, Term Frequency-Inverse Document Frequency (TF-IDF) encoding, one or more embedding layers of a neural network, and/or otherwise.

In some implementations in which the input 401 includes image data/video data/etc., the input processor 401 may resize the data to a standard size compatible with format of a corresponding input channel and/or may normalize pixel values to a common range (e.g., 0 to 1) to ensure a consistent representation, and the embedding component 420 may encode the image data using any known technique (e.g., using one or more convolutional neural networks (CNNs) to extract visual features). In some implementations in which the input 401 includes audio data, the input processor 401 may resample an audio file to a consistent sampling rate for uniform processing, and the embedding component 420 may use any known technique to extract and encode audio features—such as in the form of a spectrogram (e.g., a mel-spectrogram). In some implementations in which the input 401 includes video data, the input processor 401 may extract frames or apply resizing to extracted frames, and the embedding component 420 may extract features such as optical flow embeddings or video embeddings and/or may encode temporal information or sequences of frames. In some implementations in which the input 401 includes multi-modal data, the embedding component 420 may fuse representations of the different types of data (e.g., text, image, audio, USD, video, design, etc.) using techniques like early fusion (concatenation), late fusion (sequential processing), attention-based fusion (e.g., self-attention, cross-attention), etc.

The generative LM 430 and/or other components of the generative LM system 400 may use different types of neural network architectures depending on the implementation. For example, transformer-based architectures such as those used in models like GPT may be implemented, and may include self-attention mechanisms that weigh the importance of different words or tokens in the input sequence and/or feedforward networks that process the output of the self-attention layers, applying non-linear transformations to the input representations and extracting higher-level features. Some non-limiting example architectures include transformers (e.g., encoder-decoder, decoder only, multi-modal), RNNs, LSTMs, fusion models, diffusion models, cross-modal embedding models that learn joint embedding spaces, graph neural networks (GNNs), hybrid architectures combining different types of architectures adversarial networks like generative adversarial networks or GANs or adversarial autoencoders (AAEs) for joint distribution learning, and others. As such, depending on the implementation and architecture, the embedding component 420 may apply an encoded representation of the input 401 to the generative LM 430, and the generative LM 430 may process the encoded representation of the input 401 to generate an output 490, which may include responsive text and/or other types of data.

As described herein, in some embodiments, the generative LM 430 may be configured to access or use—or capable of accessing or using—plug-ins/APIs 495 (which may include one or more plug-ins, application programming interfaces (APIs), databases, data stores, repositories, etc.). For example, for certain tasks or operations that the generative LM 430 is not ideally suited for, the model may have instructions (e.g., as a result of training, and/or based on instructions in a given prompt, such as those retrieved using the RAG component 492) to access one or more plug-ins/APIs 495 (e.g., 3^{rd} party plugins) for help in processing the current input. In such an example, where at least part of a prompt is related to restaurants or weather, the model may access one or more restaurant or weather plug-ins (e.g., via one or more APIs), send at least a portion of the prompt related to the particular plug-in/API 495 to the plug-in/API 495, the plug-in/API 495 may process the information and return an answer to the generative LM 430, and the generative LM 430 may use the response to generate the output 490. This process may be repeated—e.g., recursively—for any number of iterations and using any number of plug-ins/APIs 495 until an output 490 that addresses each ask/question/request/process/operation/etc. from the input 401 can be generated. As such, the model(s) may not only rely on its own knowledge from training on a large dataset(s) and/or from data retrieved using the RAG component 492, but also on the expertise or optimized nature of one or more external resources—such as the plug-ins/APIs 495.

FIG. 4B is a block diagram of an example implementation in which the generative LM 430 includes a transformer encoder-decoder. For example, assume input text such as “Who discovered gravity” is tokenized (e.g., by the tokenizer 410 of FIG. 4A) into tokens such as words, and each token is encoded (e.g., by the embedding component 420 of FIG. 94A) into a corresponding embedding (e.g., of size 512). Since these token embeddings typically do not represent the position of the token in the input sequence, any known technique may be used to add a positional encoding to each token embedding to encode the sequential relationships and context of the tokens in the input sequence. As such, the (e.g., resulting) embeddings may be applied to one or more encoder(s) 435 of the generative LM 430.

In an example implementation, the encoder(s) 435 forms an encoder stack, where each encoder includes a self-attention layer and a feedforward network. In an example transformer architecture, each token (e.g., word) flows through a separate path. As such, each encoder may accept a sequence of vectors, passing each vector through the self-attention layer, then the feedforward network, and then upwards to the next encoder in the stack. Any known self-attention technique may be used. For example, to calculate a self-attention score for each token (word), a query vector, a key vector, and a value vector may be created for each token, a self-attention score may be calculated for pairs of tokens by taking the dot product of the query vector with the corresponding key vectors, normalizing the resulting scores, multiplying by corresponding value vectors, and summing weighted value vectors. The encoder may apply multi-headed attention in which the attention mechanism is applied multiple times in parallel with different learned weight matrices. Any number of encoders may be cascaded to generate a context vector encoding the input. An attention projection layer 440 may convert the context vector into attention vectors (keys and values) for the decoder(s) 445.

In an example implementation, the decoder(s) 445 form a decoder stack, where each decoder includes a self-attention layer, an encoder-decoder self-attention layer that uses the attention vectors (keys and values) from the encoder to focus on relevant parts of the input sequence, and a feedforward network. As with the encoder(s) 435, in an example transformer architecture, each token (e.g., word) flows through a separate path in the decoder(s) 445. During a first pass, the decoder(s) 445, a classifier 450, and a generation mechanism 455 may generate a first token, and the generation mechanism 455 may apply the generated token as an input during a second pass. The process may repeat in a loop, successively generating and adding tokens (e.g., words) to the output from the preceding pass and applying the token embeddings of the composite sequence with positional encodings as an input to the decoder(s) 445 during a subsequent pass, sequentially generating one token at a time (known as auto-regression) until predicting a symbol or token that represents the end of the response. Within each decoder, the self-attention layer is typically constrained to attend only to preceding positions in the output sequence by applying a masking technique (e.g., setting future positions to negative infinity) before the softmax operation. In an example implementation, the encoder-decoder attention layer operates similarly to the (e.g., multi-headed) self-attention in the encoder(s) 435, except that it creates its queries from the layer below it and takes the keys and values (e.g., matrix) from the output of the encoder(s) 435.

As such, the decoder(s) 445 may output some decoded (e.g., vector) representation of the input being applied during a particular pass. The classifier 450 may include a multi-class classifier comprising one or more neural network layers that project the decoded (e.g., vector) representation into a corresponding dimensionality (e.g., one dimension for each supported word or token in the output vocabulary) and a softmax operation that converts logits to probabilities. As such, the generation mechanism 455 may select or sample a word or token based on a corresponding predicted probability (e.g., select the word with the highest predicted probability) and append it to the output from a previous pass, generating each word or token sequentially. The generation mechanism 455 may repeat the process, triggering successive decoder inputs and corresponding predictions until selecting or sampling a symbol or token that represents the end of the response, at which point, the generation mechanism 455 may output the generated response.

FIG. 4C is a block diagram of an example implementation in which the generative LM 430 includes a decoder-only transformer architecture. For example, the decoder(s) 460 of FIG. 4C may operate similarly as the decoder(s) 445 of FIG. 4B except each of the decoder(s) 460 of FIG. 4C omits the encoder-decoder self-attention layer (since there is no encoder in this implementation). As such, the decoder(s) 460 may form a decoder stack, where each decoder includes a self-attention layer and a feedforward network. Furthermore, instead of encoding the input sequence, a symbol or token representing the end of the input sequence (or the beginning of the output sequence) may be appended to the input sequence, and the resulting sequence (e.g., corresponding embeddings with positional encodings) may be applied to the decoder(s) 460. As with the decoder(s) 445 of FIG. 4B, each token (e.g., word) may flow through a separate path in the decoder(s) 460, and the decoder(s) 460, a classifier 465, and a generation mechanism 470 may use auto-regression to sequentially generate one token at a time until predicting a symbol or token that represents the end of the response. The classifier 465 and the generation mechanism 470 may operate similarly as the classifier 450 and the generation mechanism 455 of FIG. 4B, with the generation mechanism 470 selecting or sampling each successive output token based on a corresponding predicted probability and appending it to the output from a previous pass, generating each token sequentially until selecting or sampling a symbol or token that represents the end of the response. These and other architectures described herein are meant simply as examples, and other suitable architectures may be implemented within the scope of the present disclosure.

### EXAMPLE COMPUTING DEVICE

FIG. 5 is a block diagram of an example computing device(s) 500 suitable for use in implementing some embodiments of the present disclosure. Computing device 500 may include an interconnect system 502 that directly or indirectly couples the following devices: memory 504, one or more central processing units (CPUs) 506, one or more graphics processing units (GPUs) 508, a communication interface 510, input/output (I/O) ports 512, input/output components 514, a power supply 516, one or more presentation components 518 (e.g., display(s)), and one or more logic units 520. In at least one embodiment, the computing device(s) 500 may comprise one or more virtual machines (VMs), and/or any of the components thereof may comprise virtual components (e.g., virtual hardware components). For non-limiting examples, one or more of the GPUs 508 may comprise one or more vGPUs, one or more of the CPUs 506 may comprise one or more vCPUs, and/or one or more of the logic units 520 may comprise one or more virtual logic units. As such, a computing device(s) 500 may include discrete components (e.g., a full GPU dedicated to the computing device 500), virtual components (e.g., a portion of a GPU dedicated to the computing device 500), or a combination thereof.

Although the various blocks of FIG. 5 are shown as connected via the interconnect system 502 with lines, this is not intended to be limiting and is for clarity only. For example, in some embodiments, a presentation component 518, such as a display device, may be considered an I/O component 514 (e.g., if the display is a touch screen). As another example, the CPUs 506 and/or GPUs 508 may include memory (e.g., the memory 504 may be representative of a storage device in addition to the memory of the GPUs 508, the CPUs 506, and/or other components). As such, the computing device of FIG. 5 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 5.

The interconnect system 502 may represent one or more links or busses, such as an address bus, a data bus, a control bus, or a combination thereof. The interconnect system 502 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 506 may be directly connected to the memory 504. Further, the CPU 506 may be directly connected to the GPU 508. Where there is direct, or point-to-point connection between components, the interconnect system 502 may include a PCIe link to carry out the connection. In these examples, a PCI bus need not be included in the computing device 500.

The memory 504 may include any of a variety of computer-readable media. The computer-readable media may be any available media that may be accessed by the computing device 500. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 504 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 500. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 506 may be configured to execute at least some of the computer-readable instructions to control one or more components of the computing device 500 to perform one or more of the methods and/or processes described herein. The CPU(s) 506 may each include one or more cores (e.g., one, two, four, eight, twenty-eight, seventy-two, etc.) that are capable of handling a multitude of software threads simultaneously. The CPU(s) 506 may include any type of processor, and may include different types of processors depending on the type of computing device 500 implemented (e.g., processors with fewer cores for mobile devices and processors with more cores for servers). For example, depending on the type of computing device 500, the processor may be an Advanced RISC Machines (ARM) processor implemented using Reduced Instruction Set Computing (RISC) or an x86 processor implemented using Complex Instruction Set Computing (CISC). The computing device 500 may include one or more CPUs 506 in addition to one or more microprocessors or supplementary co-processors, such as math co-processors.

In addition to or alternatively from the CPU(s) 506, the GPU(s) 508 may be configured to execute at least some of the computer-readable instructions to control one or more components of the computing device 500 to perform one or more of the methods and/or processes described herein. One or more of the GPU(s) 508 may be an integrated GPU (e.g., with one or more of the CPU(s) 506 and/or one or more of the GPU(s) 508 may be a discrete GPU. In embodiments, one or more of the GPU(s) 508 may be a coprocessor of one or more of the CPU(s) 506. The GPU(s) 508 may be used by the computing device 500 to render graphics (e.g., 3D graphics) or perform general purpose computations. For example, the GPU(s) 508 may be used for General-Purpose computing on GPUs (GPGPU). The GPU(s) 508 may include hundreds or thousands of cores that are capable of handling hundreds or thousands of software threads simultaneously. The GPU(s) 508 may generate pixel data for output images in response to rendering commands (e.g., rendering commands from the CPU(s) 506 received via a host interface). The GPU(s) 508 may include graphics memory, such as display memory, for storing pixel data or any other suitable data, such as GPGPU data. The display memory may be included as part of the memory 504. The GPU(s) 508 may include two or more GPUs operating in parallel (e.g., via a link). The link may directly connect the GPUs (e.g., using NVLINK) or may connect the GPUs through a switch (e.g., using NVSwitch). When combined together, each GPU 508 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 506 and/or the GPU(s) 508, the logic unit(s) 520 may be configured to execute at least some of the computer-readable instructions to control one or more components of the computing device 500 to perform one or more of the methods and/or processes described herein. In embodiments, the CPU(s) 506, the GPU(s) 508, and/or the logic unit(s) 520 may discretely or jointly perform any combination of the methods, processes and/or portions thereof. One or more of the logic units 520 may be part of and/or integrated in one or more of the CPU(s) 506 and/or the GPU(s) 508 and/or one or more of the logic units 520 may be discrete components or otherwise external to the CPU(s) 506 and/or the GPU(s) 508. In embodiments, one or more of the logic units 520 may be a coprocessor of one or more of the CPU(s) 506 and/or one or more of the GPU(s) 508.

Examples of the logic unit(s) 520 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Programmable Vision Accelerator (PVAs)—which may include one or more direct memory access (DMA) systems, one or more vision or vector processing units (VPUs), one or more pixel processing engines (PPEs)—e.g., including a 2D array of processing elements that each communicate north, south, east, and west with one or more other processing elements in the array, one or more decoupled accelerators or units (e.g., decoupled lookup table (DLUT) accelerators or units), etc., Vision Processing Units (VPUs), Optical Flow Accelerators (OFAs), Field Programmable Gate Arrays (FPGAs), Neuromorphic Chips, Quantum Processing Units (QPUs), Associative Process Units (APUs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 510 may include one or more receivers, transmitters, and/or transceivers that allow the computing device 500 to communicate with other computing devices via an electronic communication network, included wired and/or wireless communications. The communication interface 510 may include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 520 and/or communication interface 510 may include one or more data processing units (DPUs) to transmit data received over a network and/or through interconnect system 502 directly to (e.g., a memory of) one or more GPU(s) 508.

The I/O ports 512 may allow the computing device 500 to be logically coupled to other devices including the I/O components 514, the presentation component(s) 518, and/or other components, some of which may be built in to (e.g., integrated in) the computing device 500. Illustrative I/O components 514 include a microphone, mouse, keyboard, joystick, game pad, game controller, satellite dish, scanner, printer, wireless device, etc. The I/O components 514 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 500. The computing device 500 may be include depth cameras, such as stereoscopic camera systems, infrared camera systems, RGB camera systems, touchscreen technology, and combinations of these, for gesture detection and recognition. Additionally, the computing device 500 may include accelerometers or gyroscopes (e.g., as part of an inertia measurement unit (IMU)) that allow detection of motion. In some examples, the output of the accelerometers or gyroscopes may be used by the computing device 500 to render immersive augmented reality or virtual reality.

The power supply 516 may include a hard-wired power supply, a battery power supply, or a combination thereof. The power supply 516 may provide power to the computing device 500 to allow the components of the computing device 500 to operate.

The presentation component(s) 518 may include a display (e.g., a monitor, a touch screen, a television screen, a heads-up-display (HUD), other display types, or a combination thereof), speakers, and/or other presentation components. The presentation component(s) 518 may receive data from other components (e.g., the GPU(s) 508, the CPU(s) 506, DPUs, etc.), and output the data (e.g., as an image, video, sound, etc.).

### EXAMPLE DATA CENTER

FIG. 6 illustrates an example data center 600 that may be used in at least one embodiments of the present disclosure. The data center 600 may include a data center infrastructure layer 610, a framework layer 620, a software layer 630, and/or an application layer 640.

As shown in FIG. 6, the data center infrastructure layer 610 may include a resource orchestrator 612, grouped computing resources 614, and node computing resources (“node C.R.s”) 616(1)-616(N), where “N” represents any whole, positive integer. In at least one embodiment, node C.R.s 616(1)-616(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 616(1)-616(N) may correspond to a server having one or more of the above-mentioned computing resources. In addition, in some embodiments, the node C.R.s 616(1)-6161(N) may include one or more virtual components, such as vGPUs, vCPUs, and/or the like, and/or one or more of the node C.R.s 616(1)-616(N) may correspond to a virtual machine (VM).

In at least one embodiment, grouped computing resources 614 may include separate groupings of node C.R.s 616 housed within one or more racks (not shown), or many racks housed in data centers at various geographical locations (also not shown). Separate groupings of node C.R.s 616 within grouped computing resources 614 may include grouped compute, network, memory or storage resources that may be configured or allocated to support one or more workloads. In at least one embodiment, several node C.R.s 616 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 612 may configure or otherwise control one or more node C.R.s 616(1)-616(N) and/or grouped computing resources 614. In at least one embodiment, resource orchestrator 612 may include a software design infrastructure (SDI) management entity for the data center 600. The resource orchestrator 612 may include hardware, software, or some combination thereof.

In at least one embodiment, as shown in FIG. 6, framework layer 620 may include a job scheduler 628, a configuration manager 634, a resource manager 636, and/or a distributed file system 638. The framework layer 620 may include a framework to support software 632 of software layer 630 and/or one or more application(s) 642 of application layer 640. The software 632 or application(s) 642 may respectively include web-based service software or applications, such as those provided by Amazon Web Services, Google Cloud and Microsoft Azure. The framework layer 620 may be, but is not limited to, a type of free and open-source software web application framework such as Apache Spark™ (hereinafter “Spark”) that may use distributed file system 638 for large-scale data processing (e.g., “big data”). In at least one embodiment, job scheduler 628 may include a Spark driver to facilitate scheduling of workloads supported by various layers of data center 600. The configuration manager 634 may be capable of configuring different layers such as software layer 630 and framework layer 620 including Spark and distributed file system 638 for supporting large-scale data processing. The resource manager 636 may be capable of managing clustered or grouped computing resources mapped to or allocated for support of distributed file system 638 and job scheduler 628. In at least one embodiment, clustered or grouped computing resources may include grouped computing resource 614 at data center infrastructure layer 610. The resource manager 636 may coordinate with resource orchestrator 612 to manage these mapped or allocated computing resources.

In at least one embodiment, software 632 included in software layer 630 may include software used by at least portions of node C.R.s 616(1)-616(N), grouped computing resources 614, and/or distributed file system 638 of framework layer 620. One or more types of software may include, but are not limited to, Internet web page search software, e-mail virus scan software, database software, and streaming video content software.

In at least one embodiment, application(s) 642 included in application layer 640 may include one or more types of applications used by at least portions of node C.R.s 616(1)-616(N), grouped computing resources 614, and/or distributed file system 638 of framework layer 620. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 634, resource manager 636, and resource orchestrator 612 may implement any number and type of self-modifying actions based on any amount and type of data acquired in any technically feasible fashion. Self-modifying actions may relieve a data center operator of data center 600 from making possibly bad configuration decisions and possibly avoiding underutilized and/or poor performing portions of a data center.

The data center 600 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 600. In at least one embodiment, trained or deployed machine learning models corresponding to one or more neural networks may be used to infer or predict information using resources described above with respect to the data center 600 by using weight parameters calculated through one or more training techniques, such as but not limited to those described herein.

In at least one embodiment, the data center 600 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### EXAMPLE NETWORK ENVIRONMENTS

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 500 of FIG. 5—e.g., each device may include similar components, features, and/or functionality of the computing device(s) 500. In addition, where backend devices (e.g., servers, NAS, etc.) are implemented, the backend devices may be included as part of a data center 600, an example of which is described in more detail herein with respect to FIG. 6.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 500 described herein with respect to FIG. 5. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. One or more processors comprising:
one or more circuits to:
receive a target code segment and a corresponding specification;
generate, using a language model, a set of logical conditions for the target code segment based at least on the corresponding specification;
update the target code segment to include the set of logical conditions; and
execute a logical solver to verify the updated target code segment based at least on the set of logical conditions.

2. The one or more processors of claim 1, wherein the one or more circuits are to update the language model using a dataset comprising a training code segment and a corresponding updated code segment.

3. The one or more processors of claim 1, wherein the corresponding specification comprises at least one pre-condition and at least one post-condition for the target segment.

4. The one or more processors of claim 1, wherein the target code segment comprises at least one of a function or a loop.

5. The one or more processors of claim 1, wherein the one or more circuits are to:
generate the set of logical conditions to include at least one nested quantifier based at least on the target code segment and the corresponding specification.

6. The one or more processors of claim 1, wherein the one or more circuits are to:
identify an error in an output of the logical solver; and
generate an output message indicating the error.

7. The one or more processors of claim 6, wherein the one or more circuits are to:
provide the error as input to a second language model to generate a corrected set of logical conditions; and
update the target code segment based at least on the corrected set of logical conditions.

8. The one or more processors of claim 7, wherein the one or more circuits are to:
retrieve at least a portion of an electronic document using a search operation and the error; and
provide the portion of the electronic document as input to the second language model with the error to generate the corrected set of logical conditions.

9. The one or more processors of claim 1, wherein the one or more circuits are to:
receive the corresponding specification in a natural language format.

10. The one or more processors of claim 1, wherein the one or more processors are comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system implemented using an edge device;
a system implemented using a robot;
a system for performing conversational AI operations;
a system for performing generative AI operations using a small language model (SLM);
a system for performing generative AI operations using a large language model (LLM);
a system for performing generative AI operations using a vision language model (VLM);
a system for performing generative AI operations using a multimodal language model;
a system for generating synthetic data;
a system incorporating one or more virtual machines (VMs);
a system using or deploying one or more inference microservices;
a system that incorporates one or more machine learning models deployed in a service or microservice along with an OS-level virtualization package;
a system implemented at least partially in a data center; or
a system implemented at least partially using cloud computing resources.

11. A system, comprising
one or more processors to:
generate, using a language model, a first set of logical conditions for a target code segment;
determine, using a logical solver, that the first set of logical conditions fails to satisfy a code specification for the target code segment;
upon determining that the first set of logical conditions fails to satisfy the code specification, execute a search operation using at least a portion of the target code segment to obtain at least a portion of an electronic document;
generate, using the language model, a second set of logical conditions for the target code segment using the target code segment and the portion of the electronic document, the second set of logical conditions addressing deficiencies of the first set of logical conditions; and
integrate the second set of logical conditions into structure of the target code.

12. The system of claim 11, wherein the one or more processors are to:
determine, using the logical solver, that the second set of logical conditions satisfies the code specification; and
provide an output indicating that the second set of logical conditions satisfies the code specification.

13. The system of claim 11, wherein the one or more processors are to:
generate an error using the logical solver and the first set of logical conditions; and
execute the search operation further based on the error.

14. The system of claim 13, wherein the one or more processors are to:
generate, using the language model, the second set of logical conditions using the target code segment, the error, and the portion of the electronic document.

15. The system of claim 11, wherein the code specification is provided in a natural language format.

16. The system of claim 11, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system implemented using an edge device;
a system implemented using a robot;
a system for performing conversational AI operations;
a system for performing generative AI operations using a small language model (SLM);
a system for performing generative AI operations using a large language model (LLM);
a system for performing generative AI operations using a vision language model (VLM);
a system for performing generative AI operations using a multimodal language model;
a system for generating synthetic data;
a system incorporating one or more virtual machines (VMs);
a system using or deploying one or more inference microservices;
a system that incorporates one or more machine learning models deployed in a service or microservice along with an OS-level virtualization package;
a system implemented at least partially in a data center; or
a system implemented at least partially using cloud computing resources.

17. A method, comprising:
receiving, using one or more processors, a target code segment and a corresponding specification;
generating, using the one or more processors and a language model, a set of logical conditions for the target code segment based at least on the corresponding specification;
updating, using the one or more processors, the target code segment to include the set of logical conditions; and
executing, using the one or more processors, a logical solver to verify the updated target code segment based at least on the set of logical conditions.

18. The method of claim 17, further comprising updating, using the one or more processors, the language model using a dataset comprising a training code segment and a corresponding updated code segment.

19. The method of claim 17, wherein the corresponding specification comprises at least one pre-condition and at least one post-condition for the target segment.

20. The method of claim 17, wherein the target code segment comprises at least one of a function or a loop.
